(19) United States
(12) Patent Application Publication
(10) Pub. No.: US 2026/0285605 A1
(43) Pub. Date: Sep. 24, 2026

(54) MODULAR CONVEYOR BELT WITH ARTICLE MOVERS

(71) Applicant: Laitram, L.L.C., Harahan, LA (US)

(72) Inventors: David Aaron vanSchalkwijk, Metairie, LA (US); Daniel E. Jackson, Harahan, LA (US)

(21) Appl. No.: 19/127,312

(22) PCT Filed: Nov. 10, 2023
(86) PCT No.: PCT/US2023/079382

§ 371 Date: May 5, 2025

Related U.S. Application Data
(60) Provisional application No. 63/428,858, filed on Nov. 30, 2022.

(51) Int. Cl. B65G 17/08; B65G 17/40; B65G 17/42

(52) U.S. Cl. CPC B65G 17/08; B65G 17/40; B65G 17/42; B65G 47/844

(57) ABSTRACT

A modular conveyor belt with an article-engaging mover that sorts articles off the side of a conveyor or positions articles at positions across the width of a conveyor. As the belt advances, the mover is guided across the belt by guide rails below the belt. The mover rides in a slot that ends in one or both support modules flanking an interior portion. The slots in the support modules are continuations of a slot in the interior portion, which is formed by a pair of partial belt modules separated by a gap. Connection features align the support modules and the partial belt modules so that a continuous slot from one or both support modules to the interior portion is maintained.

### BACKGROUND

The invention relates generally to power-driven conveyors and particularly to modular conveyor belts with article-moving elements.

Conveyors are often required to selectively position articles in specific lanes for processing downstream, forming pallets, or sorting articles off the side of the conveyor. Shoe sorters are often used for those purposes. One version of a modular plastic conveyor belt analogous to a conventional shoe sorter is described in U.S. Pat. No. 9,302,855, issued Apr. 5, 2016, to Guernsey et al. In that version a pusher is mounted in a slot that extends across a portion of the width of a belt module. The pusher translates along the slot to push articles to selected lateral positions across the width of the conveyor. The conveyor belt described in that patent works well in many applications, but if a wide belt is required, the plastic modules are prone to warping along the slots, which could jam the pushers.

### SUMMARY

One version of a conveyor belt embodying features of the invention comprises a series of rows of belt modules that each extend in length from a first end to a second end, in width from a first side edge to a second side edge, and in thickness from a top side to a bottom side. At least some of the rows include a first support module having hinge elements along the first and second ends of the row and a second support module having hinge elements along the first and second ends of the row. An interior portion of each row is disposed between the first and second support modules. The interior portion includes at least one first partial belt module having hinge elements along the first end of the row and at least one second partial belt module having hinge elements along the second end of the row. The hinge elements of the first and second support modules and the at least one first partial belt module along the first end of the row are aligned, and the hinge elements of the first and second support modules and the at least one second partial belt module along the second end of the row are aligned. The at least one first partial belt module has a face that faces a face on the at least one second partial belt module across a gap through the thickness of the row to form a slot between the faces that extends across the width of the interior portion. A connection in each row joins the interior portion to the first support module and joins the interior portion to the second support module. A mover is received in the slot to move along the slot.

Another version of a conveyor belt comprises a series of rows of belt modules arranged side by side across seams between abutting belt modules and joined end to end at hinge joints. At least some of the rows are mover rows that each include a mover received in a slot that extends laterally across a portion of the row. The mover is configured to translate laterally across the slot to move conveyed articles laterally across the belt. The slot extends across one or more seams.

### BRIEF DESCRIPTION OF THE DRAWINGS

FIGS. 1A and 1B illustrate a portion of a conveyor belt embodying features of the invention from top and bottom perspectives.

FIGS. 2A and 2B are top and bottom isometric views of an edge module for a conveyor belt as in FIGS. 1A and 1B.

FIG. 3 is an exploded view from a bottom perspective of another version of a single belt row usable to construct a conveyor belt similar to the belt of FIGS. 1A and 1B.

FIG. 4 is an isometric view of a portion of another version of a conveyor belt.

FIG. 5 is an isometric view of a portion of another version of a conveyor belt having slat movers.

### DETAILED DESCRIPTION

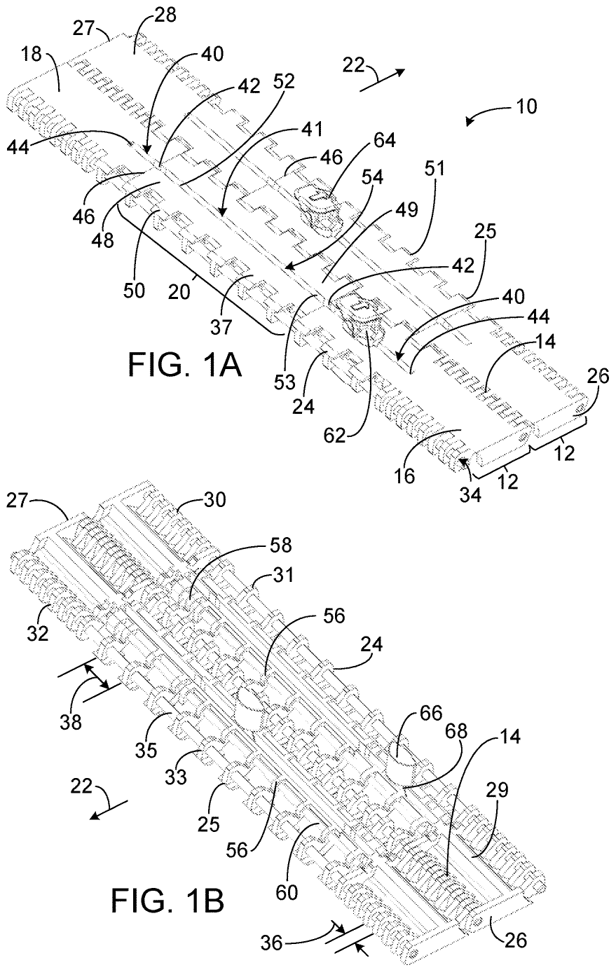

A portion of one version of a conveyor belt embodying features of the invention is shown in FIGS. 1A and 1B. The conveyor belt 10 is constructed of rows 12 of belt modules joined end to end at hinge joints 14. Each belt row 12 includes a first edge module 16, a second edge module 18, and an interior portion 20. Each row 12 extends in length in a direction of belt travel 22 from a first end 24 to a second end 25, laterally in width from a first side edge 26 to a second side edge 27, and in thickness from a top side 28 to a bottom side 29.

First hinge elements 30, 31 are laterally spaced apart across intervening spaces along the first end 24 of each row 12. Second hinge elements 32, 33 are laterally spaced apart across intervening spaces along the second end 25 of each belt row 12. The hinge elements of adjacent rows 12 are interleaved in the spaces and have laterally aligned bores 34 receiving a hinge rod 35 joining adjacent rows together at the hinge joints 14. The tops 37 of the first and second hinge elements 31, 33 are wider than the bores 34 and form extensions of the belt row's article-supporting top side 28 out to the first and second ends 24, 25 of the row 12. The transverse pitch 36 of the hinge elements 30, 32 of the edge modules 16, 18 nearer the first and second side edges 26, 27 is less than the transverse pitch 38 of the hinge elements 31, 33 in the interior of the row 12. All the hinge elements 31, 33 of the interior portion 20 and some of those on the edge modules 16, 18 have the greater transverse pitch 38. Because the edge modules 16, 18 bear the majority of the belt tension as the belt 10 is driven, the more closely spaced hinge elements 30, 32 increase the belt's pull strength. Because the interior portion 20 of the belt 10 bears little or no belt tension, its hinge elements 31, 33 can be spaced farther apart, which also makes cleaning easier. But the transverse pitch of all the hinge elements 30, 31, 32, 22 could be the same.

The edge modules 16, 18 each have a slot 40 that extends laterally from an open end 42 at its abutment with the interior portion 20 to a blind end 44 spaced inward of the first and second side edges 26, 27 of the belt row 12. The slots 40 in the edge modules 16, 18 form continuations of a slot 41 that extends across the width of the interior portion 20. So that the belt 10 can be constructed without seams 46 that are continuous along the length of the belt, the edge modules 16, 18 are arranged in a bricklay pattern with the interior portions 20. For that reason, the first edge modules 16 and the second edge modules 18 from row to row alternate in width. And, consequently, so do the corresponding slots 40 so that all the combined slots 40, 41 extend laterally the same distance across the width of the belt 10. The modular construction can be extended to include multiple interior portions 20 for constructing wide belts without concern for the warpage that can occur in wider slotted modules.

The interior portion 20 of each row 12 is formed by two partial belt modules 48, 49. The hinge elements 31 at the first end 24 of the interior portion 20 are formed on the trailing end 50 of the trailing partial belt module 48. And the hinge elements 33 at the second end 25 of the interior portion 20 are formed on the leading end 51 of the leading partial belt module 49. The opposite ends of the partial belt modules 48, 49 are devoid of hinge elements and present faces 52, 53 facing each other across a gap 54 that extends through the thickness of the belt 10 from the top side 28 to the bottom side 29. The gap 54 forms the open-ended slot 41 in the interior portion 20. In this example, the partial belt modules 48, 49 are identical, and the gap is midway between the first and second ends 24, 25. But one of the partial belt modules could be longer than the other in the direction of belt travel 22 to form the slot closer to one end of the interior portion than to the other.

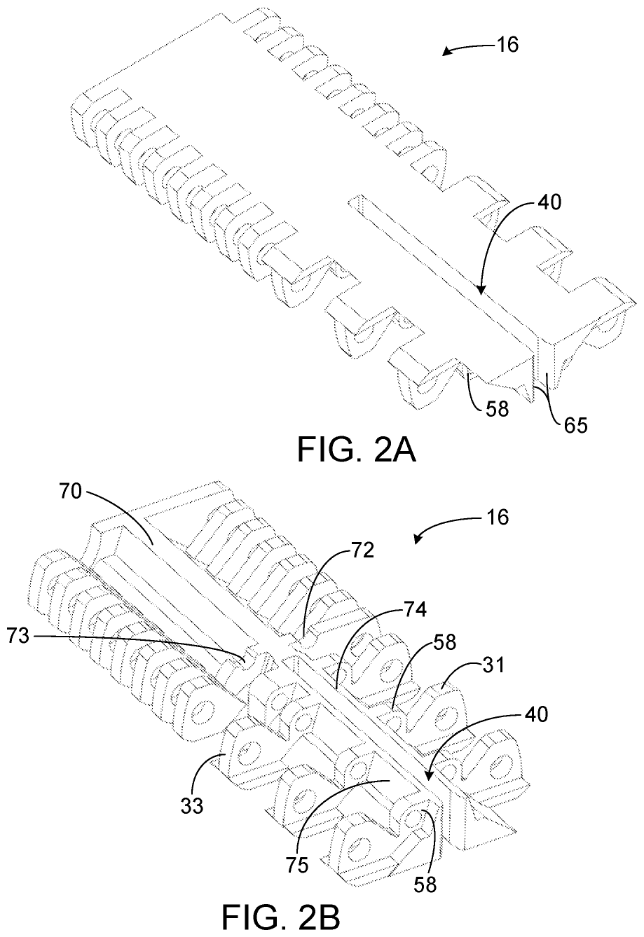

Because the two partial belt modules 48, 49 are not connected directly to each other, they are held coplanar by a connection to the laterally abutting edge modules 16, 18. Eyelets 56 on the bottom side of the partial belt modules 48, 49 are aligned with each other and with similar eyelets 58 on the edge modules 16, 18, also shown in FIGS. 2A and 2B. The eyelets 56, 58 are positioned between the more widely spaced hinge elements 31, 33 and the slot 40, 41. Connecting pins 60 received in the eyelets 56, 58 connect the partial belt modules 48, 49 to the edge modules 16, 18 and maintain the partial belt modules and the supporting edge modules in a coplanar relationship. The connection formed by the connecting pins 60 and the eyelets 56, 58 also aligns the edge modules 16, 18 to the partial belt modules 48, 49 so that the slot 41 in the interior portion 20 is aligned and continuous with the slots 40 in the edge modules.

As shown in FIGS. 1A and 1B, a mover 62 rides laterally in each aligned slot 40, 41. The mover 62 in this example has an upper pusher 64 at the top side 28 of the belt 10 and a lower follower 66 that extends below the bottom side 29. A narrower neck 68 joining the pusher 64 and the follower 66 is received in the continuous, elongated slot 40, 41. The article-engaging pusher 64 pushes conveyed articles laterally across the top side 28 of the belt 10 to a desired position, as in a conveyor switch, or over the side edge, as in a sorting conveyor. The mover 62 is guided by the follower's contact with conventional guide rails (not shown) extending along and across the conveyor under the belt 10 as the belt advances in the direction of belt travel 22. The alignment of the edge modules 16, 18 with the partial belt modules 48, 49 and the slots 40, 41 prevents the mover 62 from snagging on corners of the slots at the seams 46. And, as shown in FIG. 2A, the edges 65 of the walls bounding the slot 40 can be radiused at the seams 46 to widen the slot openings and further prevent snagging. The edges of the partial belt modules 48, 49 can be similarly radiused to widen the openings. Although the article-engaging element at the top side 28 of the belt is a pusher 64 in this example, it could instead be a carrier, such as a slat atop which conveyed articles are carried.

As better shown in FIG. 2B, the edge module 16 has a laterally extending rib 70 at the outer portion of the module. The rib 70 serves as a drive bar that is driven by a sprocket (not shown). FIG. 2B also shows the eyelets 58 with the same transverse pitch as the hinge elements 31, 33. In this example, the eyelets 58 are aligned with the hinge elements 31, 33. But the eyelets 58 could have a transverse pitch different from that of the hinge elements 31, 33. And the eyelets 58 could be laterally offset from the hinge elements 31, 33. Notches 72, 73 in structure at the bottom side of the edge module 16 facilitate insertion of the connecting pin (35, FIG. 1B) into the eyelets 58. The eyelets 58 in the edge module 16 extend from walls 74, 75 bounding the slot 40. The same is true of the eyelets 56 of the partial belt modules 48, 49.

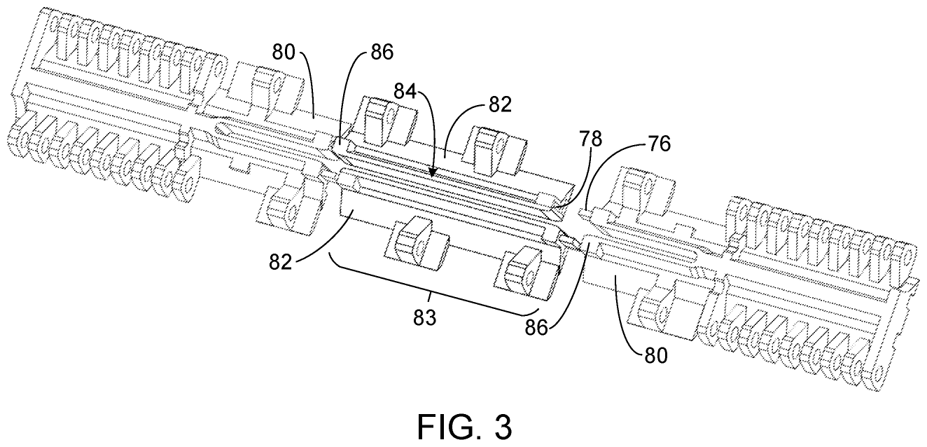

Another example of a connection between edge modules and partial belt modules for a belt as in FIGS. 1A and 1B is shown in FIG. 3. In this version the connection is formed by plugs 76 and sockets 78 in facing sides of edge modules 80 and partial belt modules 82 forming an interior portion 83 of the belt row. When the plugs 76 are received in the sockets 78, the edge modules 80 and the partial belt modules 82 are aligned so that a continuous slot 84 is formed. The plugs 76 and the sockets 78 are formed in blocks 86 at the ends of walls bounding the slot 84. The thick blocks 86 bolster the connection. Although the edge modules 80 in this version serve as support modules for the interior portion 83 formed by the partial belt modules 82 and the edge modules 16, 18 serve as support modules for the interior portion 20 of the conveyor belt 10 of FIG. 1, a belt could be constructed with intermediate support modules between the edge modules and the interior portion. The intermediate support modules would have the same connection structure as the edge modules 16, 18 of FIG. 1 or the edge modules 80 of FIG. 3. And like the edge modules, the intermediate support modules could include continuations of the interior-portion slot or could be devoid of slots. If intermediate support modules are used, the edge modules need not include slots and connection structure.

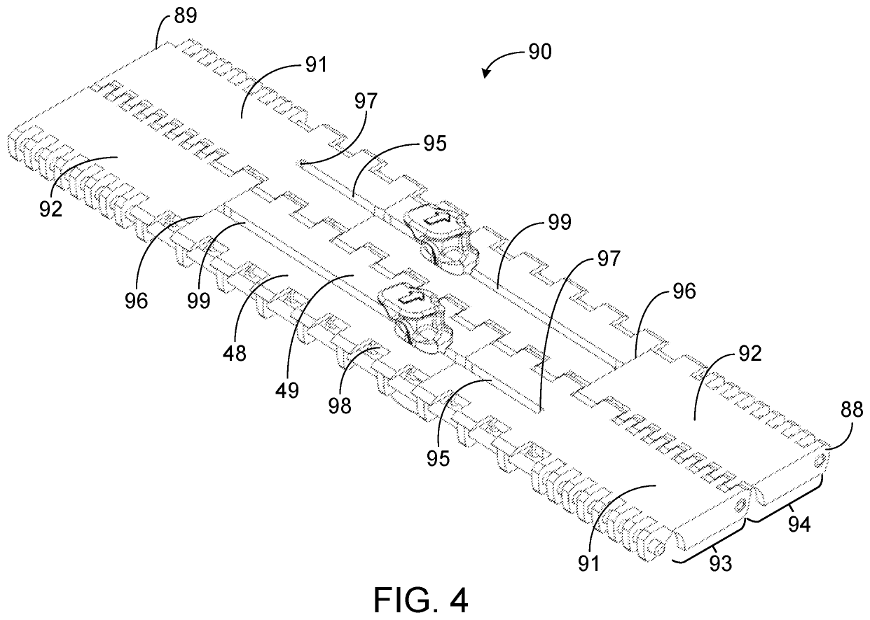

Unlike the versions shown in FIGS. 1A-3, one or both of the supporting edge modules could be devoid of slots. For example, as shown in FIG. 4, at the first side edge 88 of a bricklaid belt 90, narrower edge modules 92 in even belt rows 94 could be devoid of slots, and wider edge modules 91 in odd belt rows 93 could have slots 95 that extend to blind slot ends 97 in line with the seams 96 between the partial belt modules 48, 49 and the narrower edge modules 92 in the even belt rows 94. And at the second side edge 89 of the bricklaid belt 90, the narrower edge modules 92 in the odd belt rows 93 could be devoid of slots, and the wider edge modules 91 in the even belt rows 94 could have slots 95 that extend to blind slot ends 97 in line with the seams 96 between partial belt modules 48, 49 and the narrower edge modules 92 in the odd belt rows 93. Connection structure 98, like that of FIG. 1A or of FIG. 3, aligns the slots 95 with slots 99 formed between the partial belt modules 48, 49. Thus, the elongated slots 95, 99 in the odd belt row 93 are aligned in a lane along the length of the belt 90 with the elongated slots in the even belt rows 94. As another example, it would be possible to construct a belt with slots that extend to different lengths across the width of the belt from belt row to belt row.

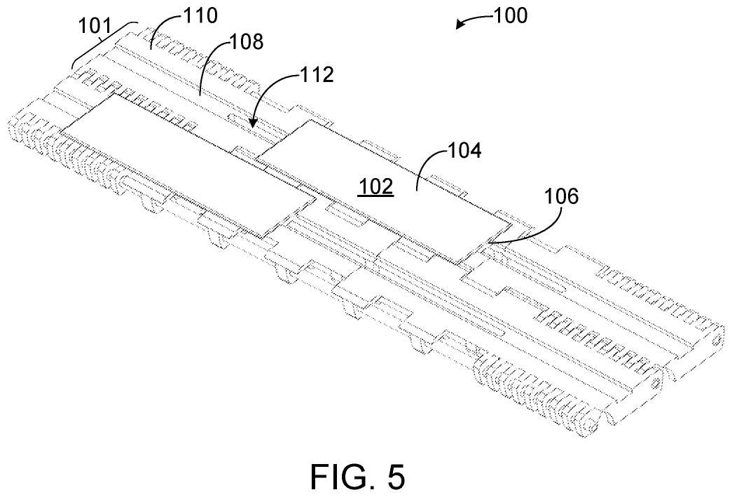

Another version of a modular conveyor belt 100 is shown in FIG. 5. At least some of the belt rows 101 have a slat-type mover 102. Instead of pushing articles, the mover 102 carries articles laterally across the width of the belt 100. The article-engaging element of the slat-type mover 102 is a top platform 104 atop which articles sit. In this version the platform is rectangular forming a slat. A slider 106 depends from and extends laterally along the bottom of the platform 104. The slider 106 is received in and rides in a recessed portion 108 of the top side 110 of the row 101. The recessed portion 108, onto which a slot 112 opens, is complementary to the shape of the slider 106 and forms a race along which the slider slides. In this version both the bottom of the recessed portion 108 and the bottom of the slider 112 are flat. The mover 102 has a narrow neck and a follower (not shown, but similar to the neck 66 and the follower 68 of the pusher 64 of FIGS. 1 and 2). The neck, which depends from the slider 106 at or near its center, rides in the slot 112. The follower depends below the bottom of the row 101 from the neck. The recessed portion 108 extends laterally across the row 101 farther than the slot 112 to allow the mover 102 to travel laterally farther along the slot. Besides a slat, a pusher or other article-engaging element with a slider sized to slide in the recessed portion 108 can be used with this belt 100.

Although features of the invention have been described with respect to a few exemplary versions, other versions are possible. For example, belt rows without slots and movers could be alternated or arranged in other patterns with mover belt rows having slots and movers. And as another example, the drive bars in the edge modules could be replaced by drive pockets engaged by sprocket teeth to drive the belt. So, as these few examples suggest, the scope of the invention is not meant to be limited to the exemplary versions used in the description.

What is claimed is:

1. A conveyor belt comprising:
a series of rows of belt modules, each row extending in length from a first end to a second end, in width from a first side edge to a second side edge, and in thickness from a top side to a bottom side;
wherein at least some of the rows include:
a first support module having hinge elements along the first and second ends of the row;
a second support module having hinge elements along the first and second ends of the row;
an interior portion disposed between the first and second support modules and including at least one first partial belt module having hinge elements along the first end of the row and at least one second partial belt module having hinge elements along the second end of the row;
wherein the hinge elements of the first and second support modules and the at least one first partial belt module along the first end of the row are aligned and the hinge elements of the first and second support modules and the at least one second partial belt module along the second end of the row are aligned;
wherein the at least one first partial belt module has a face that faces a face on the at least one second partial belt module across a gap through the thickness of the row to form a slot between the faces that extends across the width of the interior portion;
a connection joining the interior portion to the first support module and joining the interior portion to the second support module; and
a mover received in the slot to move along the slot.

2. The conveyor belt as claimed in claim 1 wherein the first support module is a first edge module forming the first side edge of the row and wherein the second support module is a second edge module forming the second side edge of the row.

3. The conveyor belt as claimed in claim 2 wherein the first edge modules of even belt rows are wider than the first edge modules of odd belt rows and the second edge modules of the odd belt rows are wider than the second edge modules of the even belt rows.

4. The conveyor belt as claimed in claim 3 wherein the first edge modules of the even belt rows and the second edge modules of the odd belt rows each have a slot that forms a continuation of the slot in the interior portion of the belt row.

5. The conveyor belt as claimed in claim 4 wherein the first edge modules of the odd belt rows and the second edge modules of the even belt rows are devoid of slots.

6. The conveyor belt as claimed in claim 2 wherein the hinge elements of the first and second edge modules that are nearer the first and second side edges have a transverse pitch that is less than the transverse pitch of the hinge elements of the interior portion.

7. The conveyor belt as claimed in claim 1 wherein the first support module has a slot forming a continuation of the slot in the interior portion to a slot end inward of the first side edge of the row to form an elongated slot.

8. The conveyor belt as claimed in claim 7 wherein the elongated slots of the rows are aligned along the length of the conveyor belt.

9. The conveyor belt as claimed in claim 7 wherein the second support module has a slot forming a continuation of the slot in the interior portion to a slot end inward of the second side edge of the row to further elongate the elongated slot.

10. The conveyor belt as claimed in claim 1 wherein the connection includes sockets or plugs on the interior portion that mate with plugs or sockets on the first and second support modules to maintain the slot through the interior portion and the slots of the first and second support modules in alignment.

11. The conveyor belt as claimed in claim 1 wherein the connection includes:
first eyelets on the interior portion and the first and second support modules between the hinge elements along the first end of the row and the slot;
second eyelets on the interior portion and the first and second support modules between the hinge elements along the second end of the row and the slot;
wherein the first eyelets are aligned and wherein the second eyelets are aligned;
a first connecting pin received in the first eyelets to retain the at least one first partial belt module in place between the first and second support modules;
a second connecting pin received in the second eyelets to retain the at least one second partial belt module in place between the first and second support modules.

12. The conveyor belt as claimed in claim 11 wherein the first eyelets and the second eyelets have the same transverse pitch as the hinge elements of the interior portion.

13. The conveyor belt as claimed in claim 1 wherein the mover includes an article-engaging element at the top side of the row, a follower at the bottom side of the row, and a neck received in the slot and joining the article-engaging element to the follower.

14. The conveyor belt as claimed in claim 1 wherein each of the at least one first partial belt modules is aligned with each of the at least one second partial belt modules.

15. The conveyor belt as claimed in claim 1 wherein the interior portion and at least one of the first and second support modules have a recessed portion of the top side of the row onto which the slot opens.

16. The conveyor belt as claimed in claim 15 wherein the mover is a slat-type mover including a top platform and a slider depending from and extending laterally along a bottom of the platform and wherein the slider slides in the recessed portion.

17. A conveyor belt comprising:
a series of rows of belt modules arranged side by side across seams between abutting belt modules and joined end to end at hinge joints;
wherein at least some of the rows are mover rows that each include a mover received in a slot that extends laterally across a portion of the row and configured to translate laterally across the slot to move conveyed articles laterally across the belt;
wherein the slot extends across one or more seams.

18. The conveyor belt as claimed in claim 17 wherein the slot is midway between the hinge joints at opposite ends of the mover row.

19. The conveyor belt as claimed in claim 17 wherein belt modules in an interior portion of the mover row are first and second partial belt modules separated in a direction of belt travel by a gap forming a portion of the slot.

20. The conveyor belt as claimed in claim 19 wherein each of the mover rows includes:
support modules abutting the interior portion at the seams;
a connection joining the partial belt modules of the interior portion to the support modules so that the partial belt modules are supported.

21. The conveyor belt as claimed in claim 20 wherein the connection maintains the slots in the support modules in alignment with the slots in the interior portion.

22. The conveyor belt as claimed in claim 20 wherein at least one of the support modules includes a slot forming a continuation of the slot in the interior portion.

23. The conveyor belt as claimed in claim 20 wherein the support modules are edge modules that define outer side edges of the conveyor belt.

24. The conveyor belt as claimed in claim 20 wherein the connection includes sockets or plugs on the interior portion that mate with plugs or sockets on the support modules.

25. The conveyor belt as claimed in claim 19 comprising a connection that includes:
first eyelets on the first partial belt module of the interior portion aligned with first eyelets on the support modules;
second eyelets on the second partial belt modules of the interior portion aligned with second eyelets on the support modules;
a first connecting pin received in the first eyelets to retain the first partial belt module in place between the support modules;
a second connecting pin received in the second eyelets to retain the second partial belt module in place between the support modules.

26. The conveyor belt as claimed in claim 19 wherein the first and second partial belt modules are identical.

27. The conveyor belt as claimed in claim 19 wherein the interior portion has a single first partial belt module and a single second partial belt module aligned across the gap.

28. The conveyor belt as claimed in claim 17 wherein the slots are wider at the seams to prevent the mover from snagging.

29. The conveyor belt as claimed in claim 17 wherein the mover rows have a recessed portion on a top side of each row onto which the slot opens.

30. The conveyor belt as claimed in claim 29 wherein the mover is a slat-type mover including a top platform and a slider depending from and extending laterally along a bottom of the platform and wherein the slider slides in the recessed portion.
